(19) United States
(12) Patent Application Publication
(10) Pub. No.: US 2006/0289750 A1
(43) Pub. Date: Dec. 28, 2006

(54) Macro-placement designing apparatus, program product, and method considering density

(75) Inventor: Ayano Yamaguchi, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 11/445,226

(22) Filed: Jun. 2, 2006

(30) Foreign Application Priority Data
Jun. 10, 2005 (JP) 2005-171675

(51) Int. Cl. G01N 23/00

(52) U.S. Cl. 250/307; 250/310

(57) ABSTRACT

According to an embodiment of the invention, a pattern density checking program product for causing a computer including a storage unit prestoring chip data about a pattern density check target chip and mask data of the chip to execute a pattern density checking process, includes: a first step of reading the mask data and creating a scribing frame model having a data ratio of a scribing frame corresponding to one density check target chip based on the mask data; and a second step of reading the chip data and executing a density check for one chip including the chip data and the scribing frame model.

### BACKGROUND OF THE INVENTION

1. Field of the Invention

The present invention relates to a semiconductor integrated circuit and a macro-placement designing technique for the semiconductor integrated circuit. In particular, the invention relates to a technique of checking a pattern density in mask data.

2. Description of Related Art

In recent years, semiconductor integrated circuits have been advancing toward miniaturization of elements. Along with this advancement, there arises a need to form fine patterns on a wafer. Patterning is executed using individual masks prepared for each step in a manufacturing process, and fine patterns are formed to overlap with each other to thereby complete a semiconductor integrated circuit. In the field of patterning, a wafer polishing technique typified by CMP (Chemical Mechanical Polishing) has been generally used. In the CMP process, the wafer surface is planarized. However, there is a possibility that the proportion of patterns to a mask used for manufacturing a semiconductor integrated circuit is too large or small depending on a layout at a design stage. In this case, patterns are polished more than necessary, in the CMP process. If patterns on a mask are polished more than necessary, the proportion of the patterns to the mask is unbalanced, and a semiconductor integrated circuit is manufactured using such a mask, the circuit faces a problem in that a malfunction occurs due to a patterning failure.

To solve the above problem, conventionally, the proportion of patterns to the entire mask (pattern density) is previously defined, and it is checked whether or not the proportion of patterns falls within a predetermined range. FIG. 14 is a schematic diagram showing a conventional mask and a range for checking a pattern density. As shown in FIG. 14, for example, a mask has such a layout that four chip patterns 1403 are formed on a single mask 1401, and a scribing frame 1402 surrounds the chip patterns 1403. Chips are cut off from each other along this frame. A range for checking a pattern density (pattern density checking area) 1406 includes all the chip patterns 1403 and the whole scribing frame 1402.

FIG. 15 is a flowchart showing a conventional manufacturing process from layout design to the start of mask formation. Referring to FIG. 15, the conventional manufacturing flow up to the start of the mask formation is described. That is, elements of fixed circuit are laid out in accordance with the layout design (step S12), and then mask data is created (step S13). A density of patterns relative to the entire mask is calculated based on the created mask data, and final check is executed to determine whether or not the calculated density falls within a prescribed range (step S14). Here, if the pattern density falls within the prescribed range, the mask formation is started (step S15); otherwise, the process returns to the layout step, and steps S12 to S14 are repeated until the pattern density falls within the prescribed range.

However, the conventional manufacturing flow from the layout design to the mask formation has a drawback that the final check cannot be executed until the complete mask data is obtained, just before the mask formation. This results in a problem in that if the pattern density cannot pass the final check, the process should return to the previous step to increase TAT (Turn Around Time) of a semiconductor integrated circuit.

To that end, Japanese Unexamined Patent Application Publication No. 2003-67441 (Related Art) discloses a technique about how to suppress pattern density errors in the final check. The Related Art aims at calculating an element pattern density relative to a surface area where macro-blocks as functional blocks of a semiconductor integrated circuit are laid out at the layout design stage. However, even this technique of the Related Art checks only the density of patterns in the macro-block, so the pattern density relative to the whole mask including up to the scribing frame surrounding the chips needs to be calculated during the final check. If the density error is found as a result of calculating the pattern density relative to the whole mask in the final check, the process should return to the previous step, resulting in a problem in that TAT is increased.

In addition, since the final check is targeted at the entire mask, an enormous amount of data is necessary for this check. This causes a problem in that it takes much time to calculate the pattern density.

### SUMMARY OF THE INVENTION

According to an aspect of the invention, a pattern density checking program product for causing a computer including a storage unit prestoring chip data about a pattern density check target chip and mask data of the chip to execute a pattern density checking process, includes: a first step of reading the mask data and creating a scribing frame model having a data ratio of a scribing frame corresponding to one density check target chip based on the mask data; and a second step of reading the chip data and executing a density check for one chip including the chip data and the scribing frame model.

Further, according to another aspect of the invention, a pattern density checking apparatus for checking a pattern density in a mask, includes: a scribing frame model creating unit for creating a scribing frame model that represents a pattern density of a scribing frame along which a wafer is cut; a macro data ratio model creating unit for creating a macro data ratio model that represents a pattern density for each of a macro-block as functional blocks in a chip based on floor plan data regarding a layout of the macro-block; and a pattern density checking unit for setting a check reference frame of a predetermined surface area for data about one chip including a scribing frame, which combines the scribing frame model, the macro data ratio model, and positional information about the macro-block of the floor plan data, and executing a pattern density check on all of the one chip including the scribing frame by use of the check reference frame.

Further, according to another aspect of the invention, a pattern density checking method for checking a pattern density on a mask using a computer, includes: reading mask data from a storage unit that prestores the mask data and chip data including a data ratio of a density check target chip; creating a scribing frame model that indicates a pattern density of a scribing frame along which a wafer is cut; and reading the chip data and executing a density check for one chip including the chip data and the scribing frame model.

According to the pattern density checking program product, method, and apparatus of the present invention, a pattern density check is executed for one chip and its surrounding scribing frame using a check reference frame. Thus, a fine pattern density in a pattern density check target area can be detected. Hence, even if the pattern density error occurs, the occurrence of the error is prevented based on the check result. Further, the pattern density check according to the present invention can be executed before the creation of the whole mask data, and the error can be detected at an early stage. Thus, the number of times the same step is repeated can be reduced to shorten TAT. Further, a pattern density check is executed on a part of the data necessary for creating a mask (data about one chip and its surrounding scribing frame), so an amount of data can be reduced as compared with the pattern density check for the whole mask data. As a result, the data processing time can be shortened.

### BRIEF DESCRIPTION OF THE DRAWINGS

The above and other objects, advantages and features of the present invention will be more apparent from the following description taken in conjunction with the accompanying drawings, in which:

FIG. 1 is a flowchart of pattern density check according to a first embodiment of the present invention;

FIG. 2A shows an example of mask data according to the first embodiment of the present invention;

FIG. 2B shows an example of the mask data according to the first embodiment of the present invention;

FIG. 2C shows an example of the mask data according to the first embodiment of the present invention;

FIG. 2D shows an example of the mask data according to the first embodiment of the present invention;

FIG. 2E shows an example of the mask data according to the first embodiment of the present invention;

FIG. 3A shows an example of a scribing frame according to the first embodiment of the present invention;

FIG. 3B shows an example of the scribing frame according to the first embodiment of the present invention;

FIG. 4A shows an example of a macro data ratio model according to the first embodiment of the present invention;

FIG. 4B shows an example of the macro data ratio model according to the first embodiment of the present invention;

FIG. 5 shows pattern density checking area and a check reference frame according to the first embodiment of the present invention;

FIG. 6 shows mask data and the pattern density checking area according to the first embodiment of the present invention;

FIG. 7 shows a pattern density checking apparatus according to the first embodiment of the present invention;

FIG. 8 is a flowchart of pattern density check according to a second embodiment of the present invention;

FIG. 9 shows a pattern density checking area and a density error area according to the second embodiment of the present invention;

FIG. 10 shows a virtual floor plan where a virtual layout area for a macro block is set according to the second embodiment of the present invention;

FIG. 11 shows a result of checking a pattern density with a second pattern density checking unit according to the second embodiment of the present invention;

FIG. 12 shows a pattern density checking area example where the layout of the macro block is changed based on the result of checking the pattern density with the second pattern density checking unit according to the second embodiment of the present invention;

FIG. 13 shows a pattern density checking apparatus according to the second embodiment of the present invention;

FIG. 14 shows a conventional pattern density checking area; and

FIG. 15 is a flowchart of a conventional mask formation process.

### DESCRIPTION OF THE PREFERRED EMBODIMENTS

The invention will be now described herein with reference to illustrative embodiments. Those skilled in the art will recognize that many alternative embodiments can be accomplished using the teachings of the present invention and that the invention is not limited to the embodiments illustrated for explanatory purposed.

### First Embodiment

A pattern density check according to a first embodiment of the present invention aims at checking a pattern density relative to one of plural chips arranged on a mask (mask data) and its surrounding scribing frame, for example.

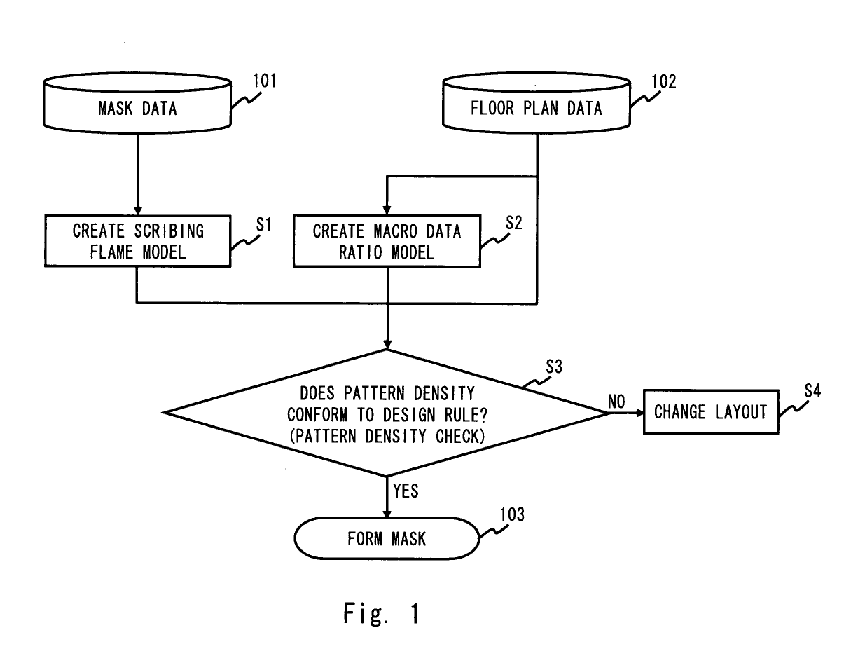

FIG. 1 is a flowchart of pattern density check of the first embodiment. Referring to FIG. 1, a flow of the pattern density check of the first embodiment is described. As shown in FIG. 1, in accordance with the pattern density check, data about the scribing frame is extracted from prepared mask data to create a scribing frame model (step S1). The scribing frame model is described in detail later. Subsequently, data about a macro-block is extracted from prepared floor plan data to create a macro data ratio model (step S2). The floor plan data represents a layout of macro-blocks as functional blocks of a semiconductor integrated circuit. The macro data ratio model is detailed later.

Next, the pattern density check is executed on data of one chip including the scribing frame, which combines the scribing frame model, the macro data ratio model, and positional information about macro-blocks in the floor plan data (step S3). If it is determined, in step S3, that the pattern density is beyond the design rule, a dummy cell is added or the layout, for example, macro placement is changed. In contrast, if it is determined, in step S3, that the pattern density conforms to the design rule, a mask is formed based on the layout. The pattern density check is detailed below. The pattern density check is executed for individual masks prepared for each layer of the layout.

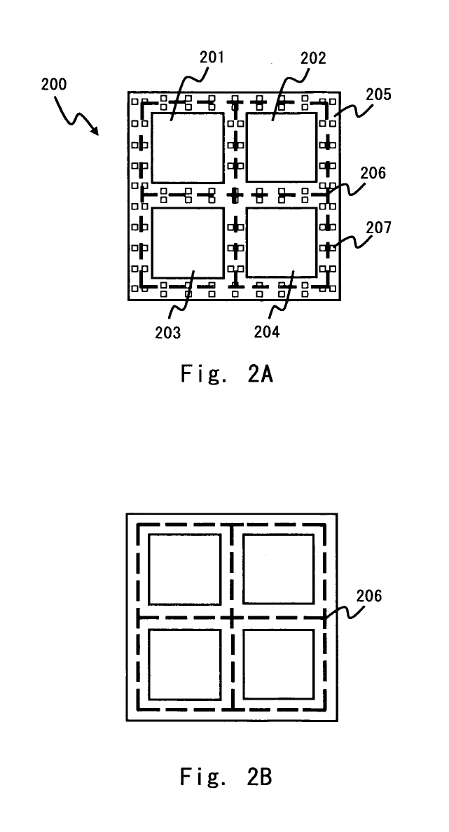

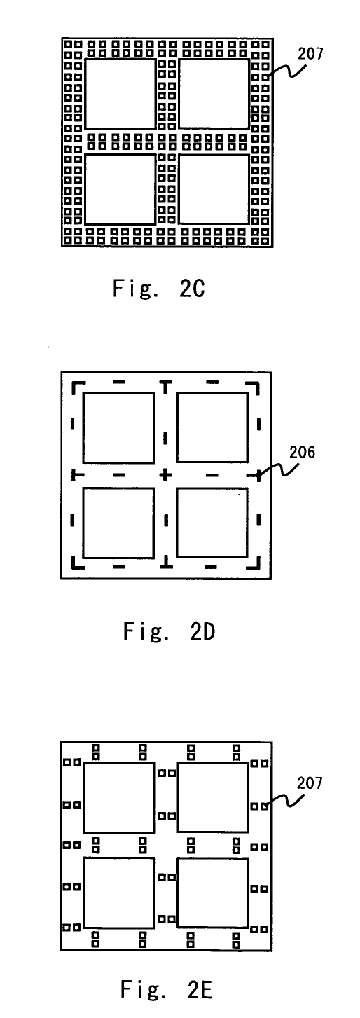

Each step of the pattern density checking flow of the first embodiment is described in detail. First, mask data 101 is prepared for each layer and determined based on a manufacturing process, a chip size, or the like. The mask data includes a scribing frame alignment mark and check mark as well as chip data. FIGS. 2A to 2E each show an example of mask data.

Mask data 200 of FIG. 2A includes data about chips 201 to 204 and a scribing frame 205. The scribing frame 205 includes an alignment mark 206 as a metal layer and a dummy cell 207 as a diffusion layer. As shown in FIGS. 2B and 2C or FIGS. 2D and 2E, the alignment mark 206 and the dummy cell 207 are layered. FIG. 2B shows a pattern example having the largest number of alignment marks 206 as the metal layer. FIG. 2C shows a pattern example having the largest number of dummy cells 207 as the diffusion layer. FIG. 2D shows a pattern example having the smallest number of alignment marks 206 as the metal layer. FIG. 2E shows a pattern example having the smallest number of dummy cells 207 as the diffusion layer. The numbers of alignment marks 206 and dummy cells 207 are determined based on manufacturing conditions.

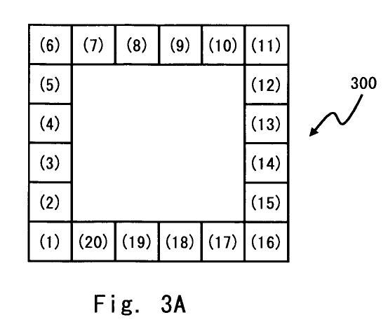

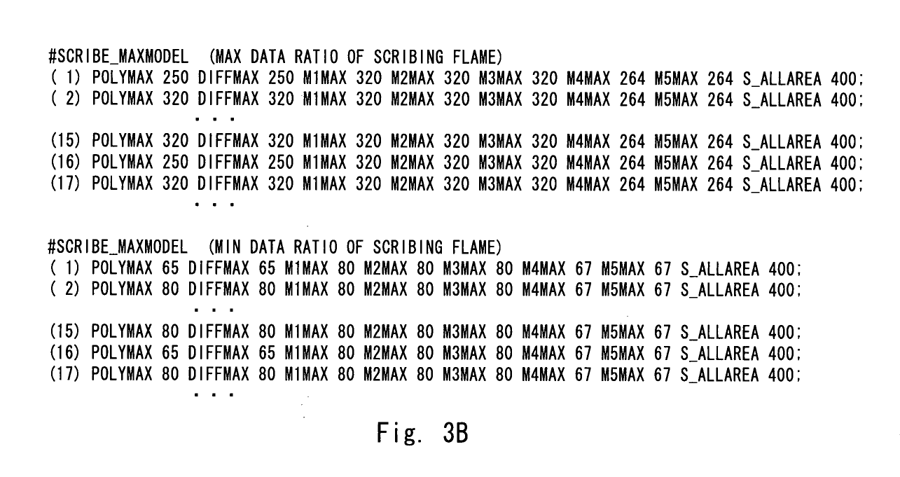

To describe the creation of the scribing frame model in step S1, the mask data 101 is input data, and a scribing frame model for one chip is created to obtain data on the scribing frame model. FIGS. 3A and 3B each show an example of the scribing frame model.

FIG. 3A schematically shows a scribing frame model 300. The scribing frame model 300 is a model of a scribing frame surrounding one chip laid out in the mask (mask data 200). In the scribing frame model 300, for example, the scribing frame surrounding one chip is divided into predetermined areas (1) to (20). The predetermined areas (1) to (20) may be set to a reference area for pattern density check which is previously determined for each manufacturing process, for example. Further, the scribing frame model 300 includes element layout data for the case where the number of alignment marks 206/dummy cells 207 is largest/smallest as shown in FIGS. 2B and 2C and FIGS. 2D and 2E. The scribing frame model 300 includes ratios of the alignment mark 206 pattern data and the dummy cell 207 pattern data to a predetermined area. The data ratio means data amounts (proportions) of the alignment mark 206 and the dummy cell 207 relative to a predetermined surface area.

FIG. 3B shows data about the scribing frame model. Following #SCRIBE_MAXMODEL, data about each area for the case where the number of alignment marks 206/dummy cells 207 is largest are described. To explain the described data, for example, S_ALLAREA represents a surface area of the predetermined area, POLYMAX represents a surface area of a polysilicon layer, DIFFMAX represents a surface area of a diffusion layer, and M1MAX, M2MAX, M3MAX, M4MAX, and M5MAX represent surface areas of aluminum lines of first to fifth layers, respectively. Further, following #SCRIBE_MINMODEL, data about each area for the case where the number of alignment marks 206/dummy cells 207 is smallest are described. To explain the described data, for example, S_ALLAREA represents a surface area of the predetermined area, POLYMIN represents a surface area of a polysilicon layer, DIFFMIN represents a surface area of a diffusion layer, and M1MIN, M2MIN, M3MIN, M4MIN, and M5MIN represent surface areas of aluminum lines of first to fifth layers, respectively. As is understood from the above explanation, the scribing frame model of FIG. 3B shows that the diffusion layer of the area (1) accounts for 250 in the case where the amount thereof is largest and accounts for 65 in the case where the amount thereof is smallest. Regarding other components, a surface area of each component can become also apparent from the data shown in FIG. 3B.

The floor plan data 102 represents sizes of three macro blocks A, B, and C, and positions thereof in a chip.

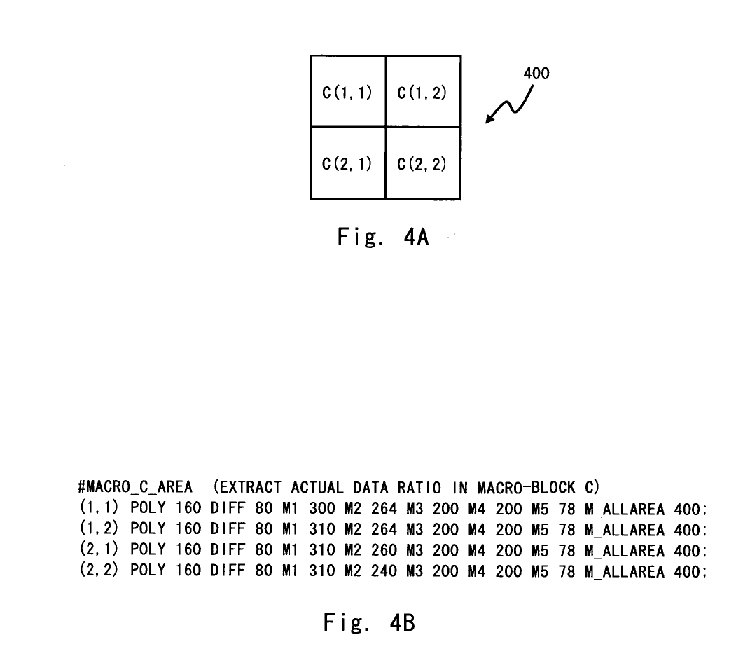

To explain the creation of the macro data ratio model in step S2, layout data about each macro block in a chip is extracted from the prepared floor plan data, and a data ratio is determined for each macro block to thereby create a macro data ratio model. FIGS. 4A and 4B each show an example of the macro data ratio model.

FIG. 4A schematically shows a macro data ratio model 400 for the macro block C. In the macro data ratio model 400, the macro block C is divided into four areas (1, 1), (1, 2), (2, 1), and (2, 2), and a data ratio is determined for each area.

FIG. 4B shows data on the macro data ratio model. Following #MACRO_C_AREA, data ratios for each area of the macro block C are described. For example, M_ALLAREA represents a surface area of the divided area of the macro block C, POLY represents a surface area of a polysilicon layer, DIFF represents a surface area of a diffusion layer, M1, M2, M3, M4, and M5 represent surface areas of aluminum lines of first to fifth layers, respectively. The macro data ratio model of FIG. 4B shows that the surface area of the area (1, 1) is 400, the polysilicon layer accounts for 160, the diffusion layer accounts for 80, the aluminum line of the first layer accounts for 300, the aluminum line of the second layer accounts for 264, the aluminum line of the third layer accounts for 200, the aluminum line of the fourth layer accounts for 200, and the aluminum line of the fifth layer accounts for 78.

To describe the pattern density check in step S3, the scribing frame model, the macro data ratio model, and the floor plan data are input data, and the density of patterns on the chip is checked in consideration of the scribing frame. Further, the result of the pattern density check is compared with the design rule data to determine whether or not the layout density of each element conforms to the design rule. The design rule data represents an upper limit and lower limit of the pattern density which are prescribed beforehand based on a target process.

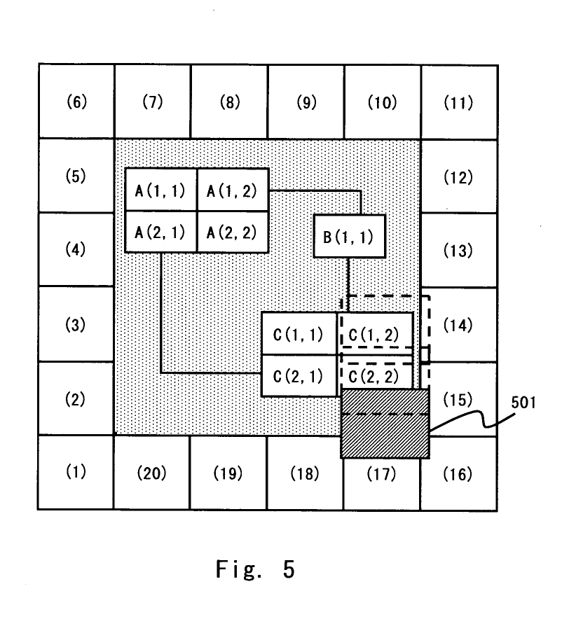

A pattern density checking method is described in detail. FIG. 5 is a schematic diagram of a scribing frame model including a chip where the macro blocks A, B, and C are arranged based on the floor plan and its surrounding scribing frame. From now on, an example of executing the pattern density check on the chip and the scribing frame of FIG. 5 is described.

The pattern density check is executed using a check reference frame 501 having a predetermined surface area. The check reference frame 501 is hatched in FIG. 5. The check reference frame 501 is moved at predetermined pitches, and the pattern density in the check reference frame 501 is calculated every movement. The check reference frame moved at predetermined pitches reaches an area surrounded by the dashed line of FIG. 5. The pattern density check is executed while calculating the pattern density in the check reference frame 501 every movement of the check reference frame. The check reference frame 501 is moved across the scribing frame model and one chip, so the pattern density can be checked over one chip and the scribing frame. The check reference frame 501 indicates an area for checking a pattern density, and may be set to a reference area for pattern density check which is previously determined for each manufacturing process, for example. The pattern density check using the check reference frame 501 is executed based on a ratio of patterns (data) to the surface area of the check reference frame 501, and a surface area occupied by the pattern (data) is calculated from the macro data ratio model and scribing frame model overlapping with the check reference frame 501.

Provided that M_ALLAREA represents a surface area of one of divided areas of a macro block, S_ALLAREA represents one of divided areas of a scribing frame, M_CROSSAREA represents a surface area of a portion where the check reference frame and the macro-block overlap with each other, S_CROSSAREA represents a surface area of a portion where the check reference frame and the scribing frame overlap with each other, and CHK_ALLAREA represents a surface area of the check reference frame, the pattern density is expressed by Expression (1):
Density in check reference frame=(α+β)/CHK_ALLAREA (1)
where α and β are expressed by the following expressions:

$$\begin{matrix}α = \sum ( macro data ratio \times ( M\_CROSSAREA / M\_ALLAREA ) ) & [ Numerical Expression 1 ] \\ β = \sum ( scribing frame model ratio \times ( S\_CROSSAREA / S\_ALLAREA ) ) & [ Numerical Expression 2 ]\end{matrix}$$

The density in check reference frame derived from Expression (1) is compared with the design rule data. The comparison result shows that the density in check reference frame is beyond the design rule, the check result (upper density limit: OK, lower density limit: NG), coordinate information (coordinates of a check reference frame, coordinates of a macro-block, and coordinates of a scribing frame), a macro-block name and a macro-block area name, the area number of the scribing frame, the density calculation result, and other such information are stored in a pattern density check result storage unit. After that, a designer adds/deletes a dummy cell or changes the floor plan based on the check result.

The pattern density check is explained with reference to actual numerical values of the model of the check reference frame 501 hatched in FIG. 5. In this case, the area (2, 2) of the macro-block C and the areas (15), (16), and (17) of the scribing frame overlap with the check reference frame 501. Here, CHK_ALLAREA, M_ALLAREA, and S_ALLAREA are set to 400. Further, the surface areas of portions where the check reference frame 501 overlaps with the area (2, 2) of the macro-block C and the areas (15), (16), and (17) of the scribing frame are 20, 80, 100, and 100, respectively. The above surface areas can be calculated based on the coordinates of the check reference frame, the coordinates of the macro-block C, and the coordinates of the scribing frame model. The pattern density check is executed on each of the polysilicon layer, the diffusion layer, and the metal layer. In this example, the calculation of only the pattern density in the polysilicon layer is described.

The density of patterns with the largest amount of polysilicon layer (MAX condition) is expressed by Expression (2).
α=(160×(20/400))=8
β=(320×(80/400)+250×(100/400)+320×(100/400)=206.5
Density in check reference frame (MAX)=(8+206.5)/400=53.6% (2)

The density of patterns with the smallest amount of polysilicon layer (MIN condition) is expressed by Expression (3).
α=(160×(20/400))=8
β=(80×(80/400)+65×(100/400)+80×(100/400)=52.25
Density in check reference frame (MIN)=(8+52.25)/400=15.1% (3)

Here, if the design rule of the polysilicon layer is 80% for the upper density limit and 20% for the lower density limit, calculation results of Expressions (2) and (3) do not conform to the design rule under the MIN conditions. In this case, in the pattern density check result storage unit, the check result (upper density limit: OK, lower density limit: NG), coordinate information (coordinates of the check reference frame, coordinates of the macro-block, and coordinates of the scribing frame), the macro-block name and the macro-block area name, the area number of the scribing frame, the density calculation result, and other such information are stored.

The designer finds that the pattern density of the polysilicon layer in the area (2, 2) of the macro-block C is insufficient, based on the above check result. Then, the designer changes the layout such as adding a dummy cell to the area (2, 2) of the macro-block C or bringing the macro-block C close to the scribing frame.

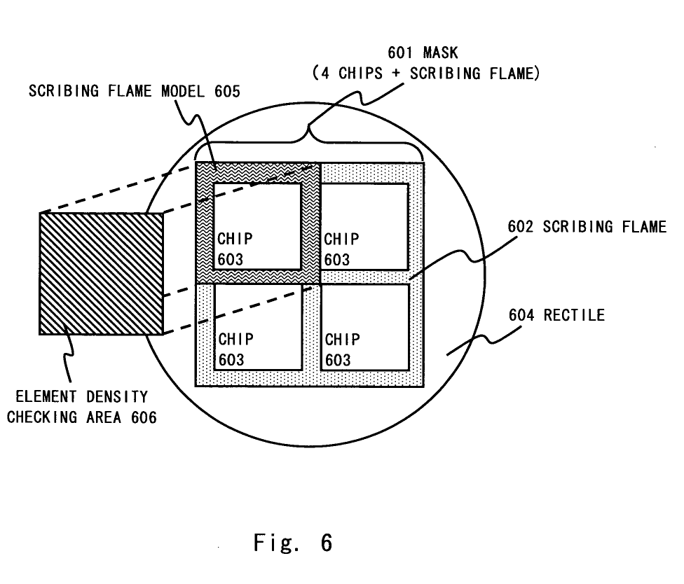

FIG. 6 shows an area 606 for checking the pattern density in the entire mask. The pattern density check of the first embodiment is not targeted for the entire mask but targeted for one of plural chips 603 arranged on a mask and its surrounding scribing frame model 605. A surface area of the area 606 for checking the pattern density is hatched in FIG. 6.

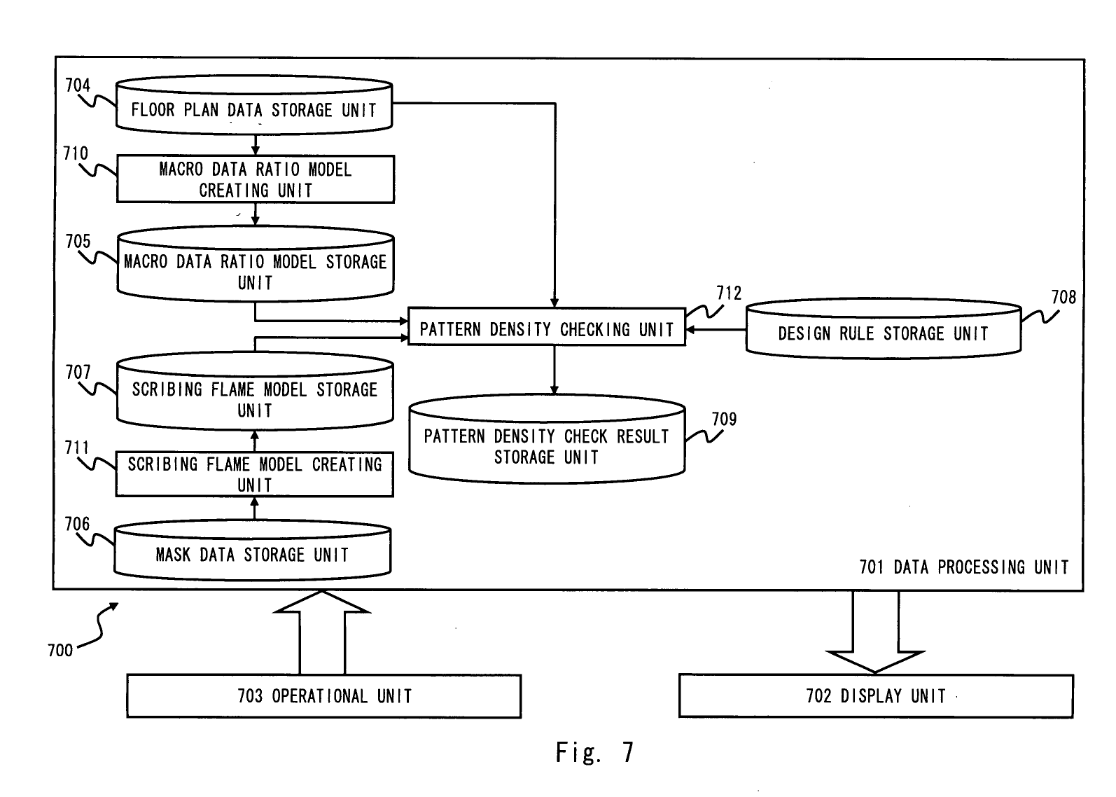

Further, FIG. 7 is a schematic diagram of a pattern density checking apparatus 700 of the first embodiment. A apparatus 700 of FIG. 7 includes a data processing unit 701 (for example, computer) for processing data for pattern density check, a display unit 702 for displaying processed data, and an operational unit 703 operated by a designer or the like to operate a computer. The data processing unit 701 incorporates a floor plan data storage unit 704 for storing floor plan data used in the above density checking flow, a macro data ratio model storage unit 705 for storing a macro data ratio model, a mask data storage unit 706 for storing mask data, a scribing frame model storage unit 707 for storing a scribing frame model, a design rule storage unit 708 for storing design rule data, a pattern density check result storage unit 709 for storing the result of checking a pattern density, a macro data ratio model creating unit 710 for creating the above macro data ratio model, a scribing frame model creating unit 711 for creating a scribing frame model, and a pattern density checking unit 712 for checking the pattern density.

As has been described above, it is possible to check a pattern density of a chip including a scribing frame using a check reference frame based on the floor plan of the chip, in accordance with the pattern density checking flow of the first embodiment. As a result, a pattern density check error can be found at the stage of drawing up a floor plan, making it possible to eliminate the possibility that the pattern density check error of mask data occurs upon the completion of designing a chip. That is, since plural chips of the same kind are arranged on the mask, the pattern density check of this embodiment adjusts the pattern density of one chip and its surrounding scribing frame to an appropriate one to thereby optimize the pattern density of the entire mask.

Further, the pattern density check is executed using the check reference frame, so coordinates of an error portion can be precisely grasped. Furthermore, it is possible to determine the degree of contribution of each macro-block to the pattern density based on the result of calculating a density in the check reference frame. That is, even if a pattern density check error occurs, it is possible to decide on a plan to change a layout (add a dummy cell or move a macro-block) based on the type of error. Hence, the pattern density check error can be eliminated at an early stage, so TAT can be shortened.

Further, in the conventional final check just before the mask formation, the pattern density check is executed on the entire mask. In this embodiment, however, the pattern density check is executed on only one chip and its surrounding scribing frame. That is, as compared with the conventional final check, an amount of data necessary for the pattern density check of this embodiment is smaller and thus, the pattern density check can be executed in a shorter period.

Incidentally, this embodiment describes an example in which the floor plan is determined, but the pattern density check can be executed using virtual macro-block data created from a provisional floor plan.

### Second Embodiment

In the pattern density check of the first embodiment, a designer arbitrarily changes a layout when the pattern density check error occurs. In contrast, in a pattern density check of a second embodiment, the pattern density check is executed once and then, if the pattern density error occurs, an errorless floor plan is set up by calculation. The same steps as those of the pattern density checking flow of the first embodiment are denoted by identical reference symbols, and their explanation is omitted here. Incidentally, in the following description about the pattern density check of the second embodiment, the pattern density check of the first embodiment (step S3) is referred to as “first pattern density check”.

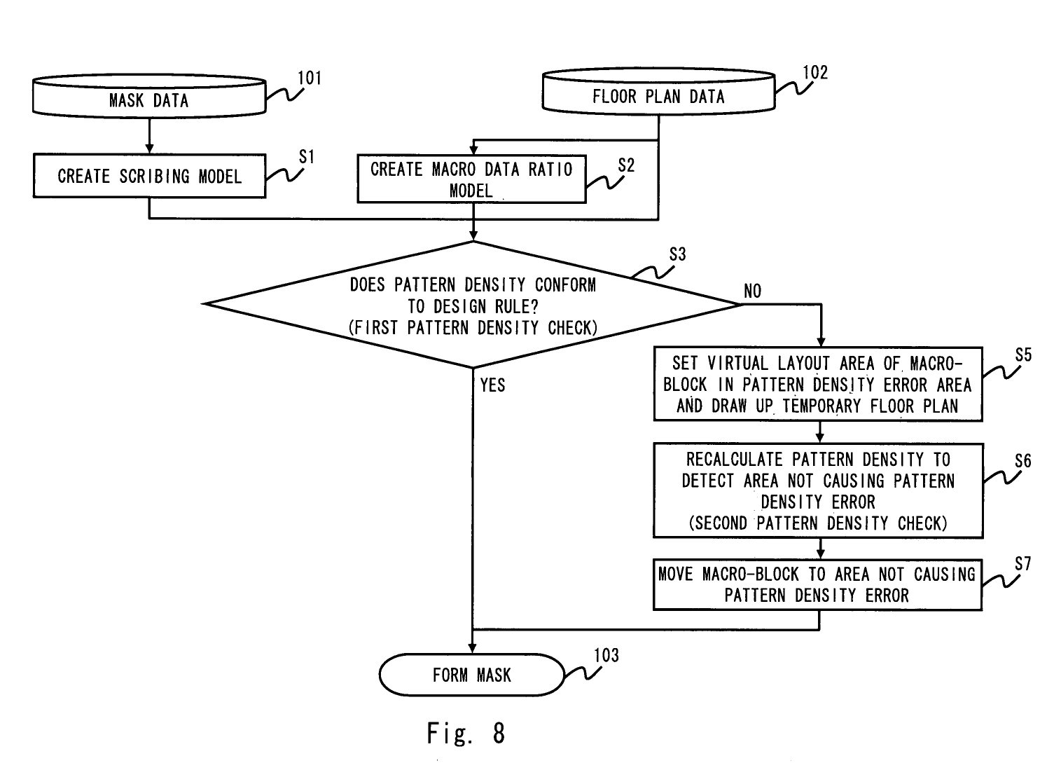

FIG. 8 is a flowchart of pattern density check of the second embodiment. Referring to FIG. 8, the pattern density checking flow of the second embodiment is described. In accordance with the pattern density checking flow of the second embodiment, if an error occurs in the first pattern density check (step S3), a given area to which the macro-block in the pattern density error area is moved is virtually set (step S5). This macro-block movement range is referred to as “virtual layout area”. Next, the pattern density in the virtual layout area set in step S5 is calculated to detect an area that would cause no pattern density error (second pattern density check (step S6)). The macro-block is moved to the area causing no pattern density error based on the detection result of step S6 (step S7). Thus, the layout that causes no pattern density error is designed, and a mask is formed based on the layout.

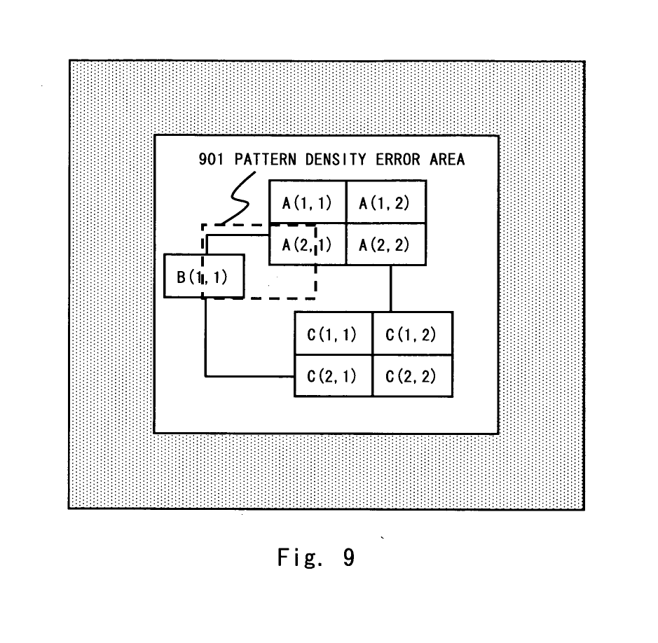

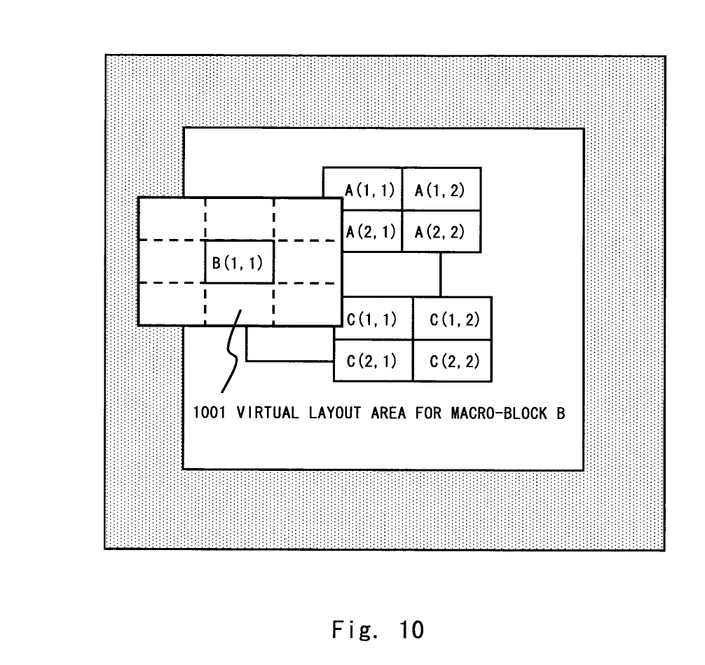

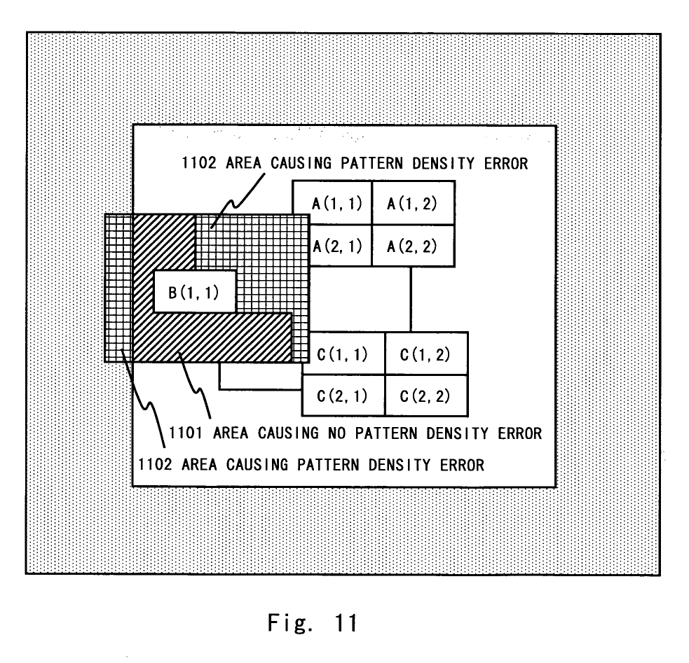

Each step of the pattern density checking flow of the second embodiment is described in detail. First, step S5 as a step of extending a target area where a macro-block in the error area is placed is described. FIG. 9 shows a pattern density checking area and an error area in this area. A square area defined by the dashed line of FIG. 9 is an area 901 that causes a pattern density check error. The pattern density error area 901 includes the macro-blocks A and B. For example, a virtual layout area is set for the macro-block B. FIG. 10 shows a temporary floor plan that sets the virtual layout area. In FIG. 10, a virtual layout area 1001 for the macro-block B is surrounded by the thick line. The virtual layout area 1001 corresponds to a surface area defined by translating the macro-block B vertically, horizontally, and obliquely, for example.

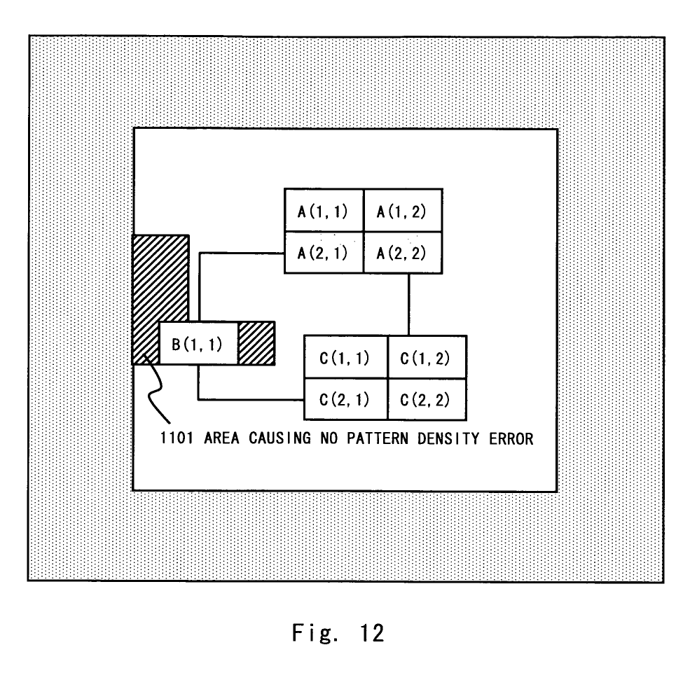

Next, in step S6, the second pattern density check is executed on the extended virtual layout area 1001 for the macro-block B. As a result of the second pattern density check, an area that would cause no density error when the macro-block B is moved is detected. FIG. 11 shows an error causing a density error and an error not causing a density error. In FIG. 11, a portion hatched in check patterns is an area 1102 causing a density error. A hatched portion is an area 1101 causing no density error. Incidentally, even the second pattern density checking unit calculates a pattern density upon the pattern density check in the same way as that of the first embodiment.

The designer moves the macro-block B to the area causing no pattern density error in step S7 based on the result of the second pattern density check in step S6. FIG. 12 shows an example of a floor plan where the macro-block B is moved.

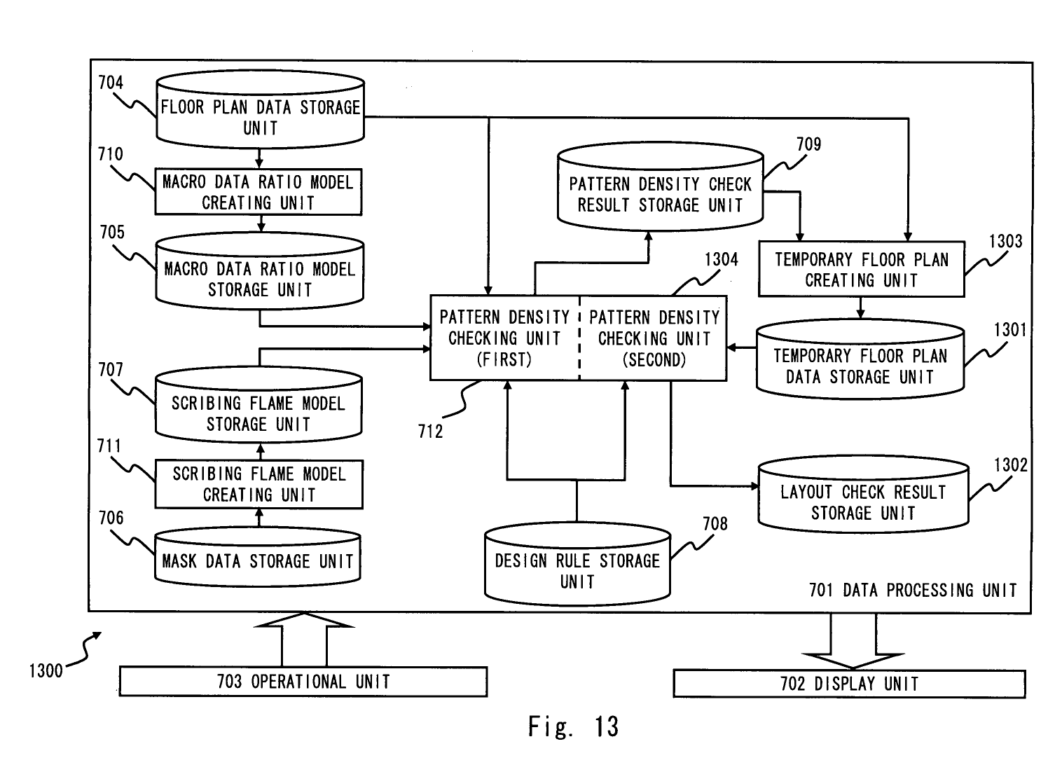

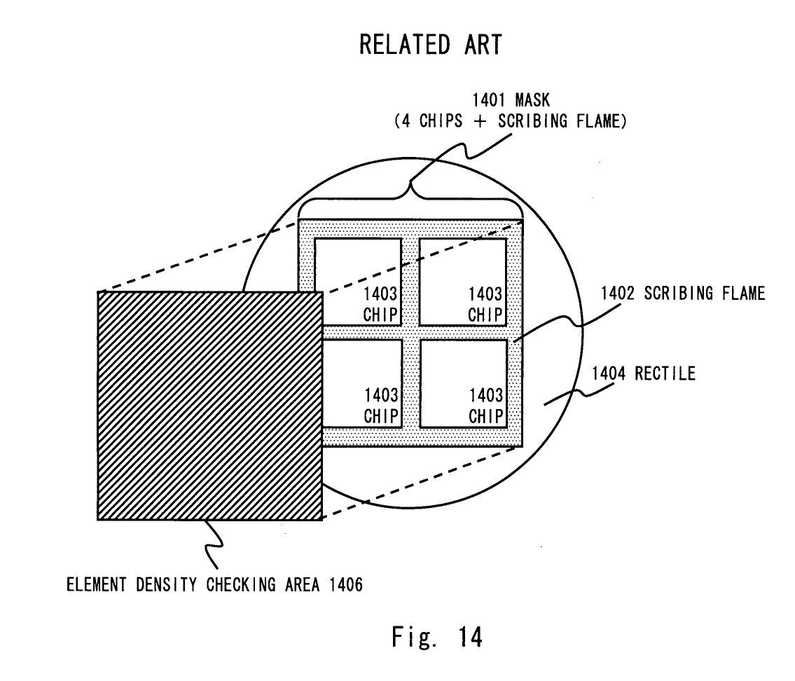

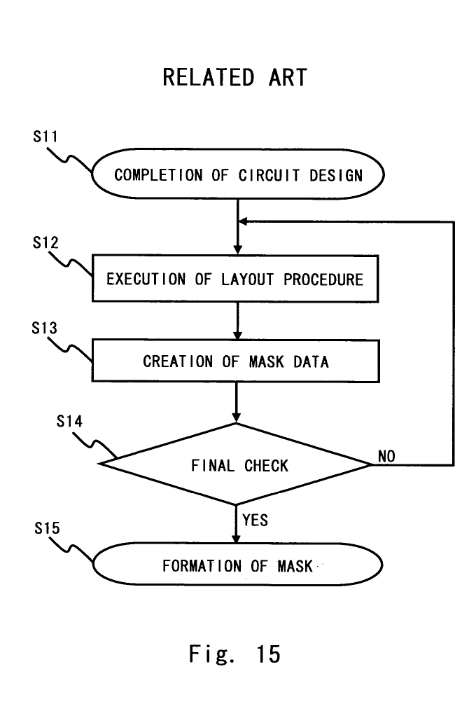

FIG. 13 shows a pattern density checking apparatus 1300 of the second embodiment. The pattern density checking apparatus 1300 of the second embodiment as shown in FIG. 13 includes a temporary floor plan data storage unit 1301 for storing temporary floor plan data, a layout check result storage unit 1302 for storing the result of the second pattern density check, a temporary floor plan creating unit 1303 for setting a virtual layout area for a macro-block, and a second pattern density checking unit 1304 for executing the second pattern density check in accordance with each process of the pattern density checking flow of the second embodiment, in addition to the components of the pattern density checking apparatus 700 of the second embodiment as shown in FIG. 7.

Even if there is an area causing a pattern density error, it is possible to determine an area causing no pattern density error by calculation in the case of moving a macro-block, in accordance with the pattern density check of the second embodiment. That is, macro-blocks can be optimally laid out without repeating the pattern density check. As a result, the number of times the step is repeated can be reduced to thereby shorten TAT.

According to the present invention, a size of a check reference frame is reduced and thus, an error area can be more finely detected, for example. In contrast, a size of a check reference frame is increased and thus, a time period necessary for the pattern density check can be reduced. Further, the pattern density check of the present invention can be also implemented by calculating a pattern density for each of the check reference frames patterned in a lattice form.

It is apparent that the present invention is not limited to the above embodiment that may be modified and changed without departing from the scope and spirit of the invention.

What is claimed is:

1. A pattern density checking program product for causing a computer including a storage unit prestoring chip data about a pattern density check target chip and mask data of the chip to execute a pattern density checking process, comprising:
a first step of reading the mask data and creating a scribing frame model having a data ratio of a scribing frame corresponding to one density check target chip based on the mask data; and
a second step of reading the chip data and executing a density check for one chip including the chip data and the scribing frame model.

2. The pattern density checking program product according to claim 1, wherein the chip data is floor plan data including layout information about a macro-block as functional blocks in a chip and the chip data includes a data ratio for the macro-block.

3. The pattern density checking program product according to claim 2, wherein in the floor plan data, the macro-block is divided into a plurality of areas having a predetermined surface area, and the floor plan data includes a data ratio for each of the divided areas.

4. The pattern density checking program product according to claim 1, wherein the second step includes executing a density check using a check reference frame of a predetermined surface area.

5. The pattern density checking program product according to claim 4, wherein if a density error is found as a result of the density check, the second step includes sending information including coordinate information about coordinates that involve the density error and macro information about a macro-block that involves the density error.

6. The pattern density checking program product according to claim 4, wherein if a density error is found as a result of the density check, the second step includes: setting a virtual layout area that virtually defines a predetermined area to which a macro-block in an area that causes the error is moved; reexecuting a pattern density check on the virtual layout area; and sending information about a movable range of the macro-block based on a result of the pattern density check.

7. The pattern density checking program product according to claim 1, wherein the scribing frame model is divided into a plurality of areas having a predetermined size.

8. The pattern density checking program product according to claim 1, wherein the scribing frame model includes an upper value and a lower value of a data ratio of patterns based on a manufacturing condition.

9. A pattern density checking apparatus for checking a pattern density in a mask, comprising:
a scribing frame model creating unit for creating a scribing frame model that represents a pattern density of a scribing frame along which a wafer is cut;
a macro data ratio model creating unit for creating a macro data ratio model that represents a pattern density for each of a macro-block as functional blocks in a chip based on floor plan data regarding a layout of the macro-block; and
a pattern density checking unit for setting a check reference frame of a predetermined surface area for data about one chip including a scribing frame, which combines the scribing frame model, the macro data ratio model, and positional information about the macro-block of the floor plan data, and executing a pattern density check on all of the one chip including the scribing frame by use of the check reference frame.

10. The pattern density checking apparatus according to claim 9, wherein the scribing frame model is divided into a plurality of areas having a predetermined size.

11. The pattern density checking apparatus according to claim 9, wherein the scribing frame model includes an upper value and a lower value of a data ratio of patterns based on a manufacturing condition.

12. The pattern density checking apparatus according to claim 11, wherein in the macro data ratio model, the macro-block is divided into a plurality of areas having a predetermined surface area, and the macro data ratio model includes a data ratio for each of the divided areas.

13. The pattern density checking apparatus according to claim 9, wherein if a density error is found, the pattern density checking unit sends information including coordinate information about coordinates that involve the density error and macro information about a macro-block that involves the density error.

14. The pattern density checking apparatus according to claim 9, wherein if a density error is found, the pattern density checking unit sets a virtual layout area that virtually defines a predetermined area to which a macro-block in an area that causes the error is moved, reexecutes a pattern density check on the virtual layout area, and sends information about a movable range of the macro-block based on a result of the pattern density check.

15. A pattern density checking method for checking a pattern density on a mask using a computer, comprising:
reading mask data from a storage unit that prestores the mask data and chip data including a data ratio of a density check target chip;
creating a scribing frame model that indicates a pattern density of a scribing frame along which a wafer is cut; and
reading the chip data and executing a density check for one chip including the chip data and the scribing frame model.

16. The pattern density checking method according to claim 15, wherein the chip data is floor plan data including layout information about a macro-block as functional blocks in a chip and the chip data includes a data ratio for the macro-block.

17. The pattern density checking method according to claim 16, wherein the floor plan data, the macro-block is divided into a plurality of areas having a predetermined surface area, and the floor plan data includes a data ratio for each of the divided areas.

18. The pattern density checking method according to claim 15, wherein the scribing frame model is divided into a plurality of areas having a predetermined size.

19. The pattern density checking method according to claim 15, wherein the density check includes executing a density check using a check reference frame of a predetermined surface area.

20. The pattern density checking method according to claim 15, wherein the scribing frame model includes an upper value and a lower value of a data ratio of patterns based on a manufacturing condition.

21. The pattern density checking method according to claim 15, wherein if a density error is found as a result of the density check, the density check includes sending information including coordinate information about coordinates that involve the density error and macro information about a macro-block that involves the density error.

22. The pattern density checking method according to claim 15, wherein if a density error is found as a result of the density check, the density check includes: setting a virtual layout area that virtually defines a predetermined area to which a macro-block in an area that causes the error is moved; reexecuting a pattern density check on the virtual layout area; and sending information about a movable range of the macro-block based on a result of the pattern density check.
